(19) United States
(12) Patent Application Publication
(10) Pub. No.: US 2024/0060287 A1
(43) Pub. Date: Feb. 22, 2024

(54) BUILDING STRUCTURE, METHOD FOR FORMING SAME, AND FUNCTIONAL PART

(71) Applicant: PORR BAU GMBH, Wien (AT)

(72) Inventors: Georg TRAUNER, Neumarkt am Wallersee (AT); Christoph STEIGER, Bischofshofen (AT); Peter KREMNITZER, Wien (AT)

(21) Appl. No.: 18/266,709

(22) PCT Filed: Dec. 10, 2021
(86) PCT No.: PCT/AT2021/060467

§ 371 Date: Jun. 12, 2023

(30) Foreign Application Priority Data
Dec. 11, 2020 (AT) GM50246/2020

(51) Int. Cl. E04B 1/21; E04B 1/78; E04B 1/16; E04C 3/34

(52) U.S. Cl. CPC E04B 1/21; E04B 1/78; E04B 1/16; E04C 3/34; E04B 2001/7679

(57) ABSTRACT

The invention relates to a building structure, a method relating thereto and a functional part (2) relating thereto, wherein the building structure comprises at least one load transfer part (1), such as a strut or a load-bearing wall, and a ceiling (3) mounted on the load transfer part (1) via a functional part (2), wherein the functional part (2) has a first bearing face (6) pointing towards the load transfer part (1) and in particular supported against the load transfer part (1), wherein the functional part (2) has a second bearing face (7) pointing towards the ceiling (3) and in particular supported against the ceiling (3), wherein the functional part (2) comprises foamed ceramic material, silicone resin and/or mica, or wherein the functional part (2) is made of foamed ceramic material, silicone resin and/or mica.

The invention relates to a building structure, a method for forming a building structure and a functional part according to the preambles to the independent claims.

The field of the invention relates in particular to building structures in which a substantially horizontally extending ceiling is supported on a plurality of load transfer parts, such as supports. In building construction, load-bearing building parts are often made of reinforced concrete. Especially in the case of connections between internal structural components and external structural components, it is often the case that, for reasons of load transfer, the structural components have to be connected to each other monolithically, in particular without joints. In particular, this concerns the connection of external supports to the storey ceiling resting directly on them.

In practice, such a monolithic connection often brings disadvantages in terms of building physics or architecture. For reasons of building physics, in particular to avoid heat loss via heat bridges, thermal insulation should be provided on the underside of the ceiling, in particular externally. However, since the supporting parts of the building are monolithically connected to each other, the thermal insulation must be interrupted at the connection points, which creates a cold bridge between the uninsulated support and the ceiling.

According to the state of the art, the thermal insulation is continued on the side of the supports.

This is usually done by a kind of sleeve made of thermal insulation material that extends from the ceiling down along the supports for a certain distance.

The sheathing of a reinforced concrete support with a sleeve is not only complex, but also often undesirable for aesthetic reasons. If the sheathing is applied over the entire support height, there is also a simultaneous reduction in the adjacent usable area or a reduction in passage widths.

It is now the object of the invention to overcome the disadvantages of the prior art and, in particular, to provide a building structure which enables a reliable connection between a load transfer part and a ceiling supported thereon and which enables a sufficiently thermally insulated connection without entailing the disadvantages found in the prior art.

In particular, the object according to the invention is solved by the features of the independent patent claims.

In particular, the invention relates to a building structure, comprising:
at least one load transfer part, such as a support or a load-bearing wall, a ceiling supported on the load transfer part via a functional part, the functional part having a first bearing surface facing in the direction of the load transfer part and supported in particular on the load transfer part, and the functional part having a second bearing surface facing in the direction of the ceiling and supported in particular on the ceiling.

Preferably, it is provided that the functional part comprises foam ceramic, silicone resin and/or mica, or that the functional part is formed from foam ceramic, silicone resin and/or mica, or that the functional part is produced from silicone resin and mica.

In the context of the present invention, foam ceramic may be understood as a ceramic material with an increased pore content and/or a porous ceramic material. Preferably, the ceramic, in particular the foam ceramic, has a thermal conductivity, in particular a thermal conductivity coefficient, at in particularly 0° C. or 100° C., of 0.15 W/(m K) up to and including W/(m K), in particular 0.26 W/(m K).

The functional part may have a first bearing surface with which the functional part is supported, optionally indirectly, on the load transfer part.

The functional part may have a second bearing surface with which the functional part is supported, optionally indirectly, on the ceiling.

Preferably, it is provided that the ceiling is supported on a load transfer part via a functional part, wherein, optionally, an intermediate layer, such as an adhesive layer, may be provided between the functional part and the ceiling and/or between the functional part and the load transfer part.

Preferably, the functional part may be in direct contact with both the ceiling and the load transfer part, whereby the functional part may also be thermally conductive. However, the functional part may be designed in such a way that it provides thermodynamic and/or fire protection advantages compared to a direct connection of the ceiling to the load transfer part.

In particular, the functional part is formed from a material that has a greater compressive strength than the material of the load transfer part. This means that the cross-sectional area of the functional part can be kept small. Due to the small cross-sectional area, the heat transfer can also be reduced. The material of the functional part can thus be selected in particular in such a way that the functional part has a higher heat transfer resistance than the load transfer part with sufficient load-bearing capacity.

Preferably, the building structure comprises several load transfer parts on which a ceiling is supported. Preferably, at least one functional part is provided on each of these load transfer parts. Preferably, the load transfer parts are designed as supports, a functional part being supported on each support.

Optionally, the load transfer part is a load-bearing wall, wherein several functional parts may be arranged next to each other on its end face pointing towards the ceiling.

The load transfer part may be a part that is subjected to pressure in the usual installation position and is set up in particular for load transfer of the inertial forces.

Examples of load transfer parts are supports, load-bearing walls, supports arranged in a V-shape, etc.

The ceiling may be a preferably self-supporting ceiling that is subjected to bending in the usual installation position and spans an area between the load transfer parts.

It is preferably provided that the functional part is suitable, set up and/or dimensioned for supporting and transmitting forces of more than 1000 kN, in particular of more than 2000 kN and particularly preferably of more than 4000 kN.

In the context of the present invention, mica may be understood as a group of minerals from the division of phyllosilicates with the same atomic structure. For example, the functional part may correspond to the type AS 600 M or AS 800 M of the company K-Therm® AS M, which are referred to as high temperature laminates. The type AS 600 M or AS 800 M of the company K-Therm® AS M can be produced from mica paper impregnated with silicone resin under high pressure and temperature.

The functional part may be, for example, a high temperature laminate made of silicone resin impregnated mica paper.

Optionally, the functional part may be a high temperature laminate made of silicone resin and mica, in particular mica paper.

Optionally, it is provided that the first bearing surface comprises at least one force transmission device, in particular at least one recess, at least one toothing, at least one nub and/or at least one elevation.

Optionally, it is provided that the at least one force transmission device of the first bearing surface is designed for positive and/or frictional connection of the functional part to the load transfer part.

Optionally, it is provided that the second bearing surface comprises at least one force transmission device, in particular at least one recess, at least one toothing, at least one nub and/or at least one elevation.

Optionally, it is provided that the at least one force transmission device of the second bearing surface is designed for positive and/or frictional connection of the functional part to the ceiling.

The at least one force transmission device may be designed in such a way that it can transmit forces, in particular thrust forces.

Optionally, it is provided that the dimensions of the first bearing surface substantially correspond to the dimensions of the second bearing surface.

Optionally, it is provided that the length and/or the width of the first bearing surface is or are substantially equal to the length and/or the width of the second bearing surface.

Optionally, it is provided that the shape of the first bearing surface substantially corresponds to the shape of the second bearing surface.

Optionally, it is provided that the cross-sectional area of the first bearing surface substantially corresponds to the cross-sectional area of the second bearing surface. In the context of the invention, the cross-sectional area may be understood as that cross-sectional area which lies in a normal plane of the load transfer direction.

Optionally, the dimensions of the load transfer part may be substantially the same as the dimensions of the first and/or second bearing surface.

Optionally, the length and/or width of the load transfer part may be substantially the same as the length and/or width of the first bearing surface and/or the second bearing surface.

If the load transfer part has a constant profile, such as a cylindrical shape or a prismatic shape, the final end face of the load transfer part, i.e. the surface on which the functional part rests, may also be larger than the first bearing surface of the functional part.

The load transfer part may project laterally in all directions beyond the first bearing surface and/or the second bearing surface.

Optionally, the second bearing surface may be designed to be larger than the cross-sectional area of the load transfer part and/or the first bearing surface, whereby the force transmission when using a functional part may be improved.

Optionally, it is provided that the functional part is designed in such a way that it has a higher heat transfer resistance than a portion of the load transfer part of the same height, while having at least the same or a higher load-bearing capacity as the load transfer part.

Optionally, it is provided that the functional part has a thermal conductivity, in particular a thermal conductivity coefficient, at in particular 0° C. or 100° C., of 0.15 W/(m K) up to and including 0.5 W/(m K), in particular 0.26 W/(m K).

Optionally, it is provided that the thermal conductivity, in particular a thermal conductivity coefficient, may be determined with the plate device according to DIN EN 12667 or DIN 52612.

Optionally, it is provided that the functional part has a limit temperature of 350° C. for at least 90 minutes.

In the context of the present invention, the limit temperature is to be understood as the temperature at which the properties of the functional part are substantially unchanged. In other words, the properties of the functional part may remain substantially unchanged when the functional part is loaded at 350° C. for at least 90 minutes.

In particular, the functional part remains dimensionally stable at 350° C. for at least 90 minutes.

In particular, the functional part maintains its dimension at 350° C. for at least 90 minutes. In particular, thermal decomposition does not take place when the functional part is loaded at 350° C. for at least 90 minutes.

Optionally, it is provided that the functional part is designed in such a way that the functional part is loadable for at least the same period of time at an equal or higher temperature, in particular the limit temperature, as the load transfer part.

Optionally, it is provided that the functional part has a limit temperature of at least 90 minutes at 350° C.

Optionally, it is provided that the height of the functional part is the distance between the first bearing surface and the second bearing surface.

Optionally, it is provided that the height of the functional part is in the range between 10 mm up to and including 500 mm, in particular between 20 mm up to and including 100 mm, and is preferably 35 mm and 70 mm.

Optionally, it is provided that thermal insulation is provided on the underside of the ceiling.

Optionally, it is provided that the thermal insulation surrounds or encloses the functional part laterally.

Optionally, it is provided that the thermal insulation projects beyond the first bearing surface of the functional part in the direction of the load transfer part.

Optionally, it is provided that the underside of the ceiling is designed to be plane-shaped and that the thermal insulation is attached to the plane-shaped underside of the ceiling.

Optionally, the functional part may be attached with its second bearing surface to the plane-shaped underside of the ceiling.

Optionally, the outer surface of the thermal insulation extends in a plane shape to several or all load transfer parts, so that several or all load transfer parts, in particular uninsulated, may project through the plane-shaped outer surface into the thermal insulation.

The load transfer part may protrude into the outer side of the thermal insulation, wherein the thermal insulation may in particular be designed in a continuous plane shape. Thereby, an aesthetically pleasing appearance can be achieved. In addition, the complex thermal insulation of a possibly column- or support-shaped load transfer part can be omitted.

The distance between the first bearing surface and the second bearing surface may define the height of the functional part, which may be smaller than the thickness of the thermal insulation.

In particular, the building structure is designed in such a way that the functional part is arranged within the thermal insulation and does not project beyond it. Rather, the thermal insulation may project beyond the functional part in the direction of the load transfer part.

Optionally, it is provided that the functional part comprises a through opening extending through the first bearing surface, through the functional part and through the second bearing surface.

Optionally, it is provided that at least one force transmission device, in particular a tube, extends through the through opening.

Optionally, it is provided that the functional part is positively and/or non-positively connected to the load transfer part and/or the ceiling by means of the at least one force transmission device.

Optionally, the at least one force transmission device, in particular the tube, may be formed of plastic, in particular of fibre-reinforced plastic, preferably glass fibre-reinforced, carbon fibre-reinforced and/or basalt-reinforced plastic.

Optionally, the at least one force transmission device, in particular the tube, may be formed from the material of the functional part.

Optionally, it is provided that the functional part comprises at least one connecting element for connecting the functional part to the load transfer part.

Optionally, it is provided that the at least one connecting element projects from the first bearing surface into the load transfer part.

Optionally, it is provided that the functional part comprises at least one connecting element for connecting the functional part to the ceiling.

Optionally, it is provided that the at least one connecting element projects from the second bearing surface into the ceiling.

Optionally, the load transfer part is connected to the ceiling and the functional part via the at least one connecting element, in particular in a positive and/or non-positive manner.

In particular, the connecting elements of the functional part may each be cast in the ceiling or in the load transfer part.

Optionally, it is provided that the at least one connecting element is designed as an anchoring or hooking element positively cast in the load transfer part or in the ceiling and, in particular, as a head bolt.

Optionally, it is provided that the at least one connecting element is designed as reinforcement and/or armouring extending through the functional part, which projects into the load transfer part or into the ceiling.

Connecting elements may be provided to connect the functional part to the ceiling and/or to the load transfer part.

According to a preferred embodiment, the connecting elements are anchor-shaped or hook-shaped and extend from the respective bearing surface towards the ceiling or towards the load transfer part. The connecting elements may be cast in the ceiling or in the load transfer part, for example.

The at least one connecting element may be designed as reinforcement and/or armouring. This reinforcement and/or armouring may extend from the load transfer part through the functional part into the ceiling. This allows the load transfer part to be connected to the functional part and the ceiling.

Optionally, it is provided that the load transfer part and/or the ceiling are formed of reinforced concrete.

Optionally, it is provided that the ceiling is a thermally insulated part of a thermally insulated building.

Optionally, the thermally insulated building may be supported on the base surface via several thermally uninsulated load transfer parts.

Optionally, it is provided that an open space, such as a parking space, which is unprotected or uninsulated from the surroundings, is provided between the load transfer parts.

Optionally, it is provided that the functional part has a compressive strength at 20° C. of 50 N/mm² up to and including 500 N/mm², in particular 100 N/mm² up to and including 450 N/mm², in particular 200 N/mm² up to and including 450 N/mm², preferably 100 N/mm², 200 N/mm², 260 N/mm², 330 N/mm², 400 N/mm² or 450 N/mm².

Optionally, it is provided that the functional part has a compressive strength at 200° C. of 50 N/mm² up to and including 280 N/mm², in particular 180 N/mm² up to and including 250 N/mm², preferably 180 N/mm², 240 N/mm₂ or 250 N/mm₂.

Optionally, it is provided that the compressive strength is determinable with a compression testing machine according to DIN EN 12390-3.

Optionally, it is provided that the functional part has a compression deformation of 1% up to and including 6%.

Optionally, it is provided that the compressive strength is determinable with a compression testing machine according to DIN EN 12390-3.

In particular, the invention relates to a method for forming a building structure, in particular designed according to the invention, comprising the following steps:
providing a formwork arrangement for forming a load transfer part made of concrete, in particular reinforced concrete,
mounting the functional part on the formwork arrangement,
optionally, filling the concrete to form the load transfer part through a passage opening of the functional part, wherein the passage opening is surrounded in particular by a spacer element designed as a tube, and in particular a reinforcement tube,
subsequently, forming a formwork arrangement for forming the ceiling above the functional part and producing the ceiling.

Optionally, it is provided that a thermal insulation is applied to the underside of the ceiling, wherein the thermal insulation projects beyond the first bearing surface of the functional part in the direction of the load transfer part.

Optionally, it is provided that the at least one force transmission device of the functional part is positively and/or frictionally connected to the ceiling and/or the load transfer part, and/or that the at least one force transmission device positively and/or frictionally connects the functional part to the load transfer part and/or the ceiling.

Optionally, the connecting elements of the functional part may be cast in the load transfer part and/or in the ceiling.

In particular, the invention relates to a functional part which is designed for use in the building structure according to the invention or is configured to be used in the building structure according to the invention or is the functional part of the building structure according to the invention.

Optionally, it is provided that the load transfer part has a first material composition and is in particular formed of reinforced concrete.

This first material composition may have a compressive strength in the range of 25 [N/mm2] to 120 [N/mm2] and a thermal conductivity of 2 [W/(mK)] up to and including 5 [W/(mK)], in particular 3 [W/(mK)].

In all embodiments, it may preferably be provided that the functional part acts exclusively as a pressure part or is loaded exclusively by pressure during any intended loading of the building structure. In particular, it is provided that no tensile stresses occur in the functional part, as this may cause the bearing plate to detach from the concrete part or cause eccentric load effects, which should preferably be avoided.

Further features according to the invention optionally emerge from the claims, the description of the exemplary embodiments, and the figures.

The invention is now further explained on the basis of non-exclusive and/or non-limiting exemplary embodiments.

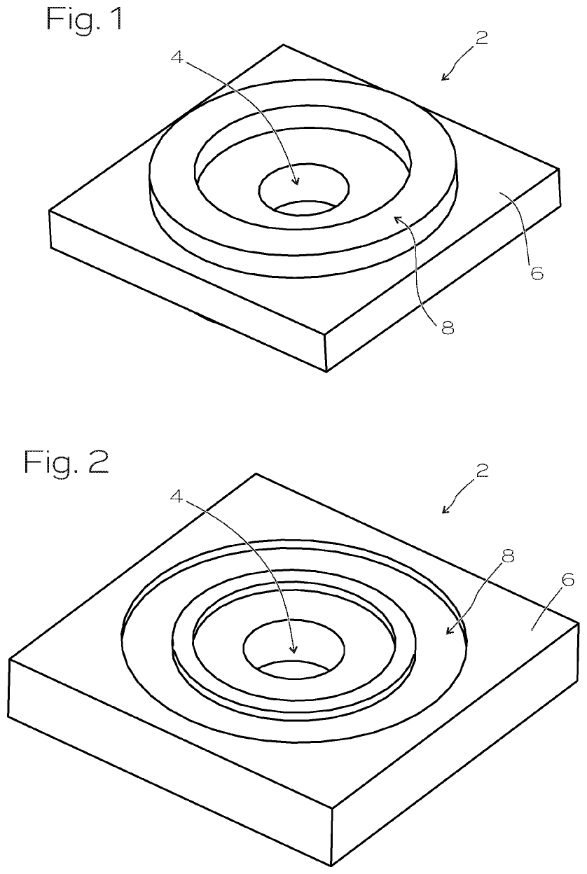

FIG. 1 shows a schematic three-dimensional view of a first embodiment of the functional part according to the invention,

FIG. 2 shows a schematic three-dimensional view of a second embodiment of the functional part according to the invention,

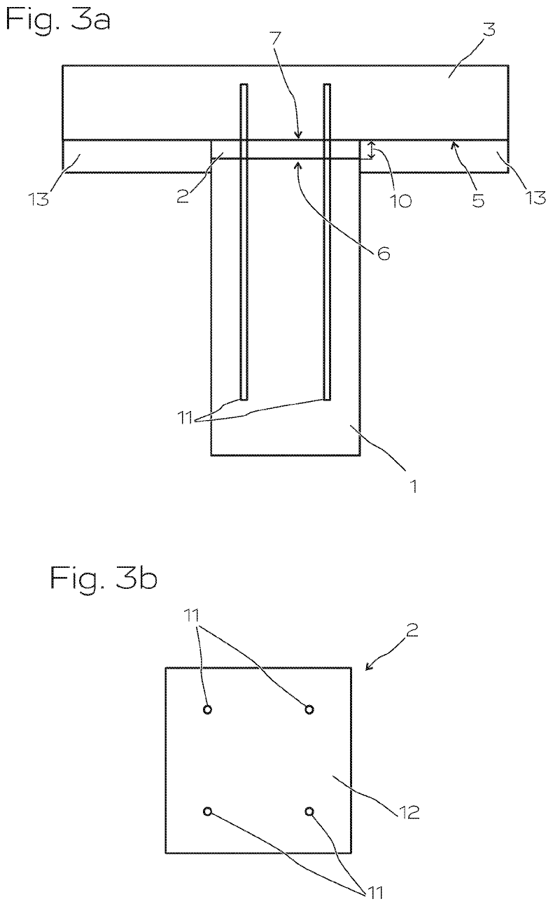

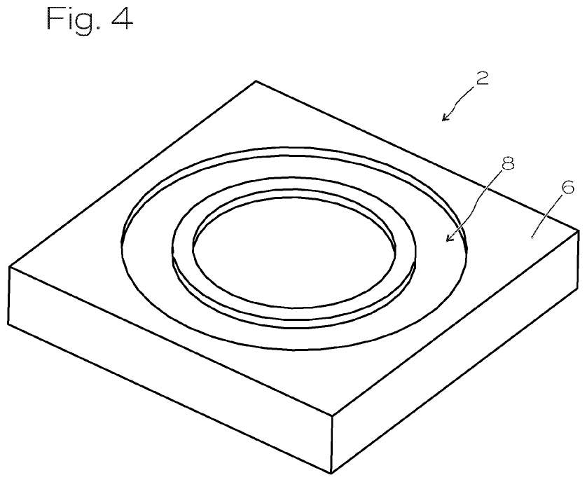

FIG. 3a shows a sectional view of an exemplary embodiment of a section of a building structure according to the invention,

FIG. 3b shows the functional part of the building structure of FIG. 3a in plan view, and

FIG. 4 shows a schematic three-dimensional view of a third embodiment of the functional part according to the invention.

Unless otherwise indicated, the reference numbers correspond to the following components: load transfer part 1, functional part 2, ceiling 3, through opening 4, underside (of the ceiling) 5, first bearing surface 6, second bearing surface 7, force transmission device 8, height (of the functional part) 10, connecting element 11, cross-sectional area (of the load transfer part) 12, and thermal insulation 13

FIG. 1 shows a schematic three-dimensional view of a first embodiment of the functional part 2 according to the invention.

According to this embodiment, the functional part 2 comprises a high-temperature laminate made of silicone resin and mica. The functional part 2 substantially corresponds to the type AS 600 M of the company K-Therm® AS M.

The first bearing surface 6 of the functional part 2 has a force transmission device 8, in particular an elevation. This force transmission device 8 is designed for positive and/or frictional connection of the functional part 2 to the load transfer part 1.

According to this embodiment, the second bearing surface (not shown) 7 of the functional part 2 also has at least one force transmission device 8, which is designed for positive and/or frictional connection of the functional part 2 to the ceiling 3.

According to this embodiment, the dimensions of the first bearing surface 6 substantially correspond to the dimensions of the second bearing surface 7. In this case, the length and the width of the first bearing surface 6 substantially correspond to the length and the width of the second bearing surface 7.

The functional part 2 is designed in such a way that it has a higher heat transfer resistance than a portion of the load transfer part 1 of the same height, while having at least the same load-bearing capacity as the load transfer part 1.

According to this embodiment, the functional part 2 has a through opening 4 extending through the first bearing surface 6, through the functional part 2 and through the second bearing surface 7.

At least one force transmission device (not shown) may extend through this through opening 4.

By means of the at least one force transmission device, the functional part 2 is positively and/or non-positively connected to the load transfer part 1 and/or the ceiling 3.

In particular, the thermal conductivity of the functional part 2 is in the range of 0.2 W/(m K) up to and including 0.5 W/(m K), in particular 0.26 W/(m K).

Furthermore, the functional part 2 has a limit temperature of at least 90 minutes at 350° C.

According to this embodiment, the functional part 2 has a compressive strength at 20° C. of 400 N/mm², a compressive strength at 200° C. of 250 N/mm² and a compression deformation of 5% up to and including 6%.

FIG. 2 shows a schematic three-dimensional view of a second embodiment of the functional part 2 according to the invention. The features of the embodiment according to FIG. 2 may preferably correspond to the features of the embodiment according to FIG. 1.

According to this embodiment, the functional part 2 is made of ceramic, preferably foam ceramic. Preferably, the ceramic, in particular the foam ceramic, has a thermal conductivity, at particularly 0° C. or 100° C., of 0.15 W/(m K) up to and including 0.5 W/(m K), in particular 0.26 W/(m K).

The first bearing surface 6 of the functional part 2 has a force transmission device 8, in particular a recess. This force transmission device 8 is designed for positive and/or frictional connection of the functional part 2 to the load transfer part 1.

According to this embodiment, the second bearing surface (not shown) 7 of the functional part 2 also has at least one force transmission device 8, which is designed for positive and/or frictional connection of the functional part 2 to the ceiling 3.

FIG. 3a shows a sectional view of an exemplary embodiment of a section of a building structure according to the invention, and FIG. 3b shows the functional part 2 of this building structure in plan view. The features of the embodiment according to FIGS. 3a and 3b may preferably correspond to the features of the embodiments according to FIGS. 1 and/or 2.

The building structure comprises at least one load transfer part 1, such as a support or a load-bearing wall, and a ceiling 3 supported on the load transfer part 1 via a functional part 2.

FIG. 3a merely shows a section of a building structure according to the invention. For example, the load transfer part 1 may also be supported, wherein this support may for example be provided on a foundation or on another part of the building.

In the present embodiment, the load transfer part 1 is designed as a support, in particular as a reinforced concrete column. The building structure may comprise several such supports, on each of which the ceiling 3 is supported via a functional part 2.

The functional part 2 comprises a first bearing surface 6. This first bearing surface 6 points in the direction of the load transfer part 1. The functional part rests with the first bearing surface 6 on the load transfer part 1.

The functional part 2 comprises a second bearing surface 7. This second bearing surface 7 points in the direction of the ceiling 3 and supports the ceiling 3.

In the present embodiment, the first bearing surface 6 and the second bearing surface 7 run parallel to each other. However, in particular in the case of a load transfer part 1 running at an angle, inclined configurations are also possible, in which the two bearing surfaces 6, 7 run at an angle to each other.

The height 10 of the functional part 2 is the distance between the first bearing surface 6 and the second bearing surface 7. According to this embodiment, the height is 70 mm.

According to this embodiment, the functional part 2 comprises four connecting elements 11 for connecting the functional part 2 to the load transfer part 1. The connecting elements are designed as reinforcements and/or armouring extending through the functional part 2, which project into the load transfer part 1 or into the ceiling 3.

In particular, the connecting elements 11 may each be cast in the ceiling 3 or in the load transfer part 1.

In other words, the connecting elements 11 project from the first bearing surface 6 into the load bearing part 1 and from the second bearing surface 7 up into the ceiling 3. Furthermore, the connecting elements 11 extend through the functional part 2. Thereby, the functional part 2 is connected to the load transfer part 1 and the ceiling 3.

According to this embodiment, the load transfer part 1 and the ceiling 3 are made of reinforced concrete.

The ceiling 3 is a thermally insulated part of a thermally insulated building, which is supported on a base surface via several thermally uninsulated load transfer parts 1.

A free space that is unprotected or uninsulated from the surroundings, such as a parking space, is provided between the load transfer parts 1.

Furthermore, a thermal insulation 13 is provided on the underside 5 of the ceiling 3. This thermal insulation 13 surrounds the functional part 2 and encloses the functional part 2 laterally.

According to this embodiment, the thermal insulation 13 projects beyond the first bearing surface 6 of the functional part 2 in the direction of the load transfer part 1. The functional part 2 is arranged and designed in such a way that it does not reach the outer side at any point.

To form a building structure according to the invention, a method may comprise, for example, the following steps:
providing a formwork arrangement for forming a load transfer part 1 made of concrete, in particular reinforced concrete.
mounting the functional part 2 on the formwork arrangement.
optionally, subsequently: Filling the concrete to form the load transfer part 1 through a through opening 4 of the functional part 2.
optionally, casting the at least one connecting element 11 of the functional part 2 in the load transfer part 1.
subsequently: Formation of a formwork arrangement for forming the ceiling 3 and producing of the ceiling 3, wherein in this case it is also preferred that at least one connecting element 11 is cast in the ceiling 3.

FIG. 4 shows a schematic three-dimensional view of a third embodiment of the functional part 2 according to the invention. The features of the embodiment according to FIG. 4 may preferably correspond to the features of the embodiments according to FIGS. 1, 2, 3a and/or 3b.

According to this embodiment, the functional part 2 is made of foam ceramic. Preferably, the foam ceramic has a thermal conductivity, at in particular 0° C. or 100° C., of 0.15 W/(m K) up to and including 0.5 W/(m K), in particular 0.26 W/(m K).

The first bearing surface 6 of the functional part 2 has a force transmission device 8, in particular a recess. This force transmission device 8 is designed for positive and/or frictional connection of the functional part 2 to the load transfer part 1.

According to this embodiment, the second bearing surface (not shown) 7 of the functional part 2 also has at least one force transmission device 8, in particular a recess, which is designed for positive and/or frictional connection of the functional part 2 to the ceiling 3.

In particular, the functional part 2 is connected to the ceiling 3 and/or the load transfer part 1, in particular in a toothed manner, by the force transmission device 8. Preferably, transverse forces that occur as a result are transferred from the load transfer part 1 to the ceiling 3 via the force transfer device 8.

According to this embodiment, the functional part 2 has no reinforcements, no armouring and no through opening 4.

In all embodiments, the functional part 2 may preferably be used as a prefabricated part and/or delivered to the construction site and placed on a formwork arrangement. When placing on the formwork arrangement, the functional part 2 may be set up in such a way that the position of the functional part 2 is exactly determined.

Optionally, thermal insulation 13 may be applied to the underside 5 of the ceiling 3. This thermal insulation 13 may project beyond the first bearing surface 6 of the functional part 2 in the direction of the load transfer part 1.

It may be provided that the at least one force transmission device 8 of the functional part 2, in particular at least one recess, at least one toothing, at least one nub and/or at least one elevation, is positively connected and/or frictionally connected to the ceiling 3 and/or the load transfer part 1.

It may be provided that the at least one force transmission device 8 of the functional part 2, in particular at least one recess, at least one toothing, at least one nub and/or at least one elevation, is positively connected and/or frictionally connected to the ceiling 3 and/or the load transfer part 1.

The invention is not limited to the illustrated embodiments, but rather comprises any building structure, method and functional part according to the following claims.

1. A building structure, comprising:
at least one load transfer part (1), such as a support or a load-bearing wall,
a ceiling (3) supported by a functional part (2) on the load transfer part (1),
wherein the functional part (2) has a first bearing surface (6) facing in the direction of the load transfer part (1) and supported in particular on the load transfer part (1),
and wherein the functional part (2) has a second bearing surface (7) facing in the direction of the ceiling (3) and supported in particular on the ceiling (3),
characterised
in that the functional part (2) comprises foam ceramic, silicone resin and/or mica,
or in that the functional part (2) is formed from foam ceramic, silicone resin and/or mica,
or in that the functional part (2) is produced from silicone resin and mica.

2. The building structure according to claim 1, characterised
in that the first bearing surface (6) has at least one force transmission device (8), in particular at least one recess, at least one toothing, at least one nub and/or at least one elevation,
and in that the at least one force transmission device (8) is designed for positive and/or frictional connection of the functional part (2) to the load transfer part (1).

3. The building structure according to claim 1, characterised
in that the second bearing surface (7) has at least one force transmission device (8), in particular at least one recess, at least one toothing, at least one nub and/or at least one elevation,
and in that the at least one force transmission device (8) is designed for positive and/or frictional connection of the functional part (2) to the ceiling (3).

4. The building structure according to claim 1, characterised
in that the dimensions of the first bearing surface (6) substantially correspond to the dimensions of the second bearing surface (7),
and/or in that the length and/or the width of the first bearing surface (6) substantially correspond to the length and/or the width of the second bearing surface (7),
and/or in that the shape of the first bearing surface (6) substantially corresponds to the shape of the second bearing surface (7).

5. The building structure according to claim 1, characterised
in that the functional part (2) is designed in such a way that it has a higher heat transfer resistance than a portion of the load transfer part (1) of the same height, while having at least the same load-bearing capacity as the load transfer part (1),
and/or in that the functional part (2) has a thermal conductivity of 0.15 W/(m K) up to and including 0.5 W/(m K), in particular 0.26 W/(m K),
and/or in that the functional part (2) has a limit temperature of 350° C. for at least 90 minutes.

6. The building structure according to claim 1, characterised
in that the height (10) of the functional part (2) is the distance between the first bearing surface (6) and the second bearing surface (7),
and in that the height (10) of the functional part (2) is in the range from 10 mm up to and including 500 mm, in particular from 20 mm up to and including 100 mm, and is preferably 35 mm and 70 mm.

7. The building structure according to claim 1, characterised
in that thermal insulation (13) is provided on the underside (5) of the ceiling (3),
in that the thermal insulation (13) surrounds or encloses the functional part (2) laterally,
and in that the thermal insulation projects beyond the first bearing surface (6) of the functional part (2) in the direction of the load transfer part (1).

8. The building structure according to claim 1, characterised
in that the functional part (2) comprises a through opening (4) extending through the first bearing surface (6), through the functional part (2) and through the second bearing surface (7),
in that at least one force transmission device, in particular a tube, extends through the through opening (4),
and in that the functional part (2) is positively and/or non-positively connected to the load transfer part (1) and/or the ceiling (3) by means of the at least one force transmission device.

9. The building structure according to claim 1, characterised
in that the functional part (2) comprises at least one connecting element (11) for connecting the functional part (2) to the load transfer part (1),
and in that the at least one connecting element (11) projects from the first bearing surface (6) into the load transfer part (1).

10. The building structure according to claim 1, characterised
in that the functional part (2) comprises at least one connecting element (11) for connecting the functional part (2) to the ceiling (3),
and in that the at least one connecting element (11) projects from the second bearing surface (7) into the ceiling (3).

11. The building structure according to claim 9, characterised
in that the at least one connecting element (11) is designed as an anchoring or hooking element positively cast in the load transfer part (1) or in the ceiling (3) and, in particular, as a head bolt,
and/or in that the at least one connecting element (11) is designed as reinforcement and/or armouring extending through the functional part and projecting into the load transfer part (1) or into the ceiling (3).

12. The building structure according to claim 1, characterised in that the load transfer part (1) and/or the ceiling (3) are formed of reinforced concrete.

13. The building structure according to claim 1, characterised
in that the ceiling (3) is a thermally insulated part of a thermally insulated building,
and in that the thermally insulated building is supported on the base surface via several thermally uninsulated load transfer parts (1).

14. The building structure according to claim 13, characterised in that an open space, such as a parking space, which is unprotected or uninsulated from the surroundings is provided between the load transfer parts (1).

15. The building structure according to claim 1, characterised
in that the functional part (2) has a compressive strength at 20° C. of 50 N/mm² up to and including 500 N/mm², in particular 100 N/mm² up to and including 450 N/mm², in particular 200 N/mm² up to and including 450 N/mm², preferably 100 N/mm², 200 N/mm², 260 N/mm², 330 N/mm², 400 N/mm² or 450 N/mm²,
and/or in that the functional part (2) has a compressive strength at 200° C. of 50 N/mm² up to and including 280 N/mm², in particular 180 N/mm² up to and including 250 N/mm², preferably 180 N/mm², 240 N/mm² or 250 N/mm²,
and/or in that the functional part (2) has a compression deformation of 1% up to and including 6%.

16. A method for forming a building structure according to claim 1, comprising the following steps:
providing a formwork arrangement for forming a load transfer part (1) made of concrete, in particular reinforced concrete,
mounting the functional part (2) on the formwork arrangement,
optionally, filling the concrete to form the load transfer part (1) through a passage opening (4) of the functional part (2), wherein the passage opening (4) is surrounded in particular by a spacer element designed as a tube, and in particular a reinforcement tube,
subsequently, forming a formwork arrangement for forming the ceiling (3) above the functional part (2) and producing the ceiling (3).

17. The method according to claim 16, characterised in that a thermal insulation (13) is applied to the underside (5) of the ceiling (3), the thermal insulation (13) projecting beyond the first bearing surface (6) of the functional part (2) in the direction of the load transfer part (1).

18. The method according to claim 16, characterised
in that the at least one force transmission device (8) of the functional part (2) is positively connected and/or frictionally connected to the ceiling (3) and/or the load transfer part (1),
and/or in that the functional part (2) is positively and/or non-positively connected to the load transfer part (1) and/or the ceiling (3) by means of the at least one force transmission device.

19. The method according to claim 16, characterised in that the connecting elements (11) of the functional part (2) are cast in the load transfer part (1) and/or in the ceiling (3).

20. A functional part (2), characterised in that the functional part (2) is designed for use in the building structure according to claim 1.
